(19) United States
(12) Patent Application Publication
(10) Pub. No.: US 2006/0009257 A1
(43) Pub. Date: Jan. 12, 2006

(54) Multifunctional personal portable digital image capturing device

(76) Inventor: Hao-Min Ku, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/085,102

(22) Filed: Mar. 22, 2005

(30) Foreign Application Priority Data
Jul. 9, 2004 (TW) 93214247

(51) Int. Cl. H04Q 7/20

(52) U.S. Cl. 455/556.1; 455/426.1

(57) ABSTRACT

A multifunctional personal portable digital image capturing device comprises a digital image capturing device. The digital image capturing device has at least a built-in or external sensor for detecting physical quantities of a source to be measured as a signal. The signal is processed by a built-in circuit component, and the detection result is then displayed on a display of the digital image capturing device. The result is also sent to an external equipment via a communications transmission device or a network interface. The personal portable digital image capturing device has also an socket for connection with a wired telephone line. In addition to performing communication in a wireless way via the communications transmission device, the personal portable digital image capturing device can also use the wired telephone line to communicate with the exterior, supply power, and charge the battery.

### FIELD OF THE INVENTION

The present invention relates to a personal portable digital image capturing device and, more particularly, to a multifunctional portable digital image capturing device.

### BACKGROUND OF THE INVENTION

Digital cameras are popular worldwide. They almost substitute conventional mechanical cameras. Other personal portable processors like handheld computers and PDAs are widely appreciated due to their compact sizes and convenient portability. Nowadays, people make every effort to integrate multiple functions into various instruments and equipments. Therefore, devices having memory function and convenient for portability like digital cameras and PDAs are hoped to have more powerful functions.

Generally speaking, if one needs to drink outside and there is no device for him to determine whether his alcohol concentration exceeds the prescribed level for driving, it will be very dangerous for him to drive a car. Moreover, a policeman in duty usually encounters a drunken driver unwilling to do an alcohol test so that the policeman can't immediately search and collect evidences at the incident site. Under the situation of insufficient evidences, both sides individually accuse the opposite side, resulting in a large dispute. If there is a device capable of collecting data like time, place, and the result of the alcohol test and directly transmitting to a database at the police business center, the data collected as evidences will have credibility. On the other hand, in order to know where water is drinkable, specialized equipments like pH value tester, oxygen concentration meter, and minerals tester are required. For most people, it would be best that a water quality testing function is added in an electronic equipment, which directly shows whether water is drinkable or not. In prior art, there is no alcohol tester or water quality tester on digital image capturing devices like digital still camera and digital camcorder. If digital image capturing devices have the functions of measuring the alcohol concentration and water quality, their practicability will be enhanced.

Accordingly, the present invention aims to propose a multifunctional personal portable digital image capturing device to solve the above problems in the prior art.

### SUMMARY AND OBJECTS OF THE PRESENT INVENTION

An object of the present invention is to provide a multifunctional personal portable digital image capturing device. At least one detector is disposed on a personal portable digital image capturing device to facilitate measurement of physical quantities of a source to be measured at any time at any place.

Another object of the present invention is to provide a multifunctional personal portable digital image capturing device with a communications transmission device installed thereon to make communications transmission with the exterior in a wireless way. A socket is used to connect externally with a public telephone line. The personal portable digital image capturing device can use the public telephone line communicate with the exterior, supply power, and charge the battery.

Another object of the present invention is to provide a multifunctional personal portable digital image capturing device. A multifunctional processor provided to perform analysis, calculation, and plotting to the measured data. The shoot mode can be chosen through a touch panel or voice control. A satellite positioner and a range finder can also be used to record the longitude and latitude of the picture-taking site.

Another object of the present invention is to provide a multifunctional personal portable digital image capturing device, which makes use of a network interface built in the communications transmission device to connect to the network and transmit the measured data or captured audiovisual file to a computer, the Internet, or related peripherals, and can also browse webpages.

Another object of the present invention is to provide a multifunctional personal portable digital image capturing device, which can remotely take a picture or video and use a range finder to measure the distance from the target to the personal portable digital image capturing device.

Another object of the present invention is to provide a multifunctional personal portable digital image capturing device, which provides a micro-projector to project out the scene selected by or video data stored in the personal portable digital image capturing device.

To achieve the above objects, the present invention provides a multifunctional personal portable digital image capturing device. A personal portable digital image capturing device has at least a built-in or external sensor for detecting physical quantities of a source to be measured as a signal. The signal is processed by a circuit component, and a display circuit directly displays the detection result on a screen of the digital image capturing device. For example, the display circuit displays the alcohol concentration value in the form of digit representation or the water quality in the form of light or sound. A communications transmission device and a network card can also be installed in the personal portable digital image capturing device to transmit out the measured data in a wired or wireless way. The circuit of the communications transmission device is included in the circuit component. In addition to performing communication in a wireless way via the communications transmission device, the personal portable digital image capturing device can also use a public telephone line connected with a socket on the personal portable digital image capturing device to communicate with the exterior, supply power, and charge the battery. Therefore, a user can make use of the convenient portability of the personal portable digital image capturing device to measure physical quantities of external environment at any situation and also perform communications transmission.

The various objects and advantages of the present invention will be more readily understood from the following detailed description when read in conjunction with the appended drawings, in which:

### BRIEF DESCRIPTION OF DRAWING

FIG. 1 is a diagram showing that a built-in sensor and an external sensor are simultaneously installed for measuring alcohol concentration in the present invention;

FIG. 2 is a block diagram of the present invention embodied with a digital still camera for taking a picture and measuring the alcohol concentration simultaneously;

FIGS. 3a and 3b are diagrams of the present invention with a communications transmission device installed;

FIG. 4 is a block diagram of the present invention with an external sensor installed;

FIGS. 5a and 5b are diagrams of the present invention showing that a built-in sensor is installed for measuring the water quality;

FIG. 6 is a diagram of the present invention with a micro-projector installed;

FIGS. 7a and 7b are diagrams of the present invention placed in a protection box; and

FIG. 8 is a diagram of the present invention showing that a remote controller is used and the captured image is projected out to a larger screen.

### DETAILED DESCRIPTION OF PREFERRED EMBODIMENT

In the present invention, at least a sensor is installed on a personal portable digital image capturing device for measuring physical quantities of a source to be measured. The digital image capturing device can use a sensor to selectively measure different environment parameters like alcohol concentration, water quality, mineral, gas, antiseptic, and insecticides to accomplish diversified measurement effect and expand the practicability of product. Several languages are provided for the personal portable digital image capturing device for use. A communications transmission device can further be installed on the digital image capturing device. The screen of the communications transmission device is jointly used with the digital image capturing device. The applicable range of the present invention is broad. The digital image capturing device includes digital still camera, digital camcorder, and digital video camera. The present invention will be exemplified below with a digital video camera having probing/detection and communications transmission functions for measuring the alcohol concentration and water quality.

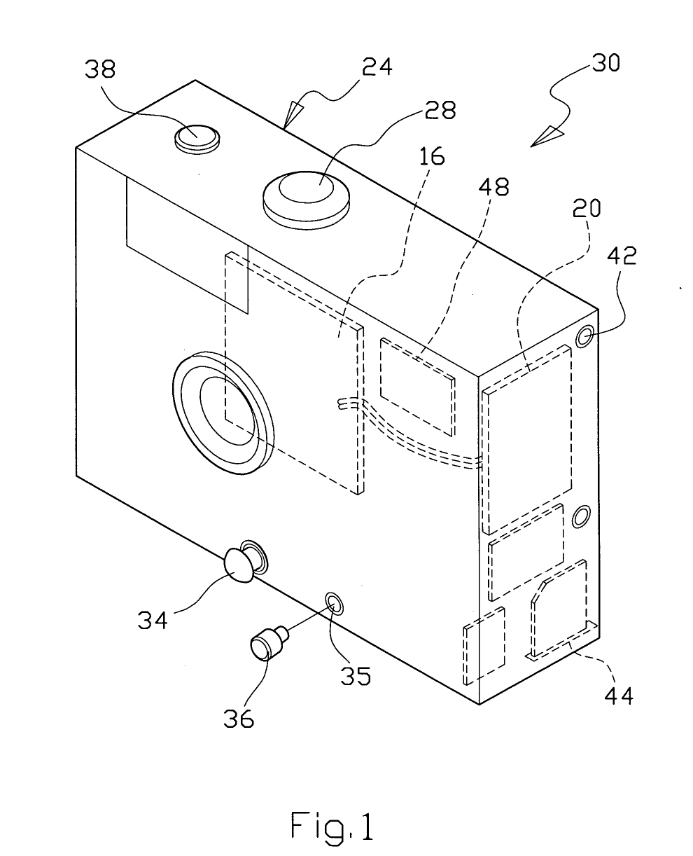

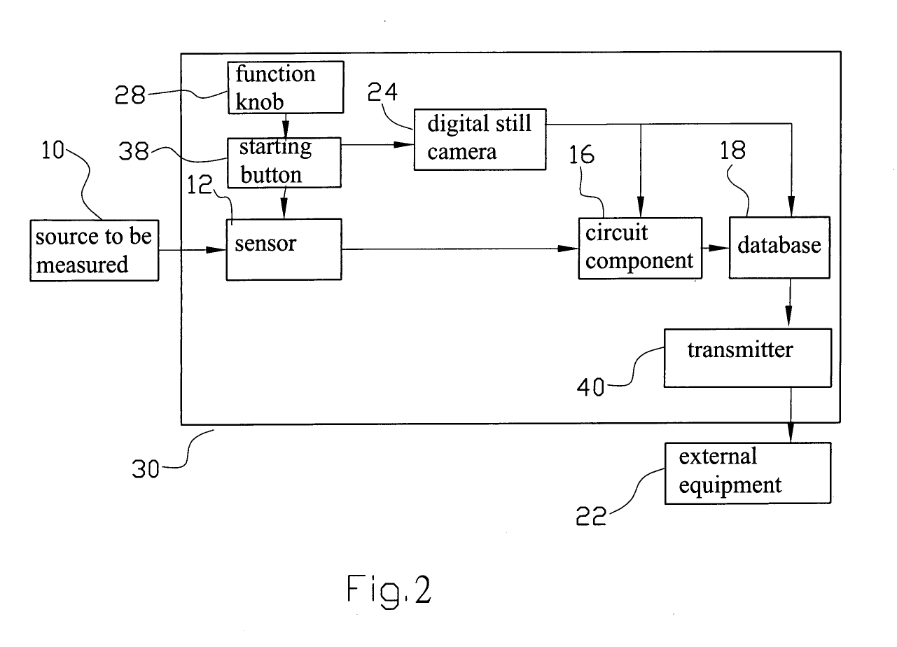

As shown in FIGS. 1 and 2, a digital video camera 24 capable of taking video has a built-in circuit component 16 and a network card 20 for processing detection signals and communications transmission signals, respectively. Two kinds of sensors 12 are installed on the digital video camera 24 to let the digital video camera 24 have detection and transmission functions and become a multifunctional personal portable digital video camera 30 (briefly termed as digital video camera 30 below). The sensors 12 include a built-in sensor 34 and an external sensor 36. The built-in sensor 34 can be a retractable sensing rod. The external sensor 36 makes use of a sensor insertion hole 35 to connect with the digital video camera 30. Both the built-in sensor 34 and the external sensor 36 can detect all contact type or non-contact type detection items. When the detectable items built-in the circuit component 16 is insufficient, a card can be inserted into a card slot 44 to enhance the detection function of the sensors 12. Besides, the digital video camera 30 has a data processor 48 capable of performing analysis, calculation, and plotting to detection data. It is not necessary for a user to transmit data to a computer for performing the above actions. Through the data processor 48, the user can directly view a menu on the screen of the digital video camera 30. The data processor 48 has also the function of selecting the shoot mode through a touch panel or voice control. The shoot mode will be exhibited with clear patterns, animation, and voice so that the user can easily select the most appropriate mode when taking a picture. Moreover, the size of photo can be freely chosen. The data processor 48 has also the satellite positioning function. The data processor 48 can use a satellite positioner to make sure the longitude and latitude of the picture-taking site. When the digital video camera 30 is used for evidence collection, this satellite positioning function can enhance the credibility of the evidences.

The function menu of the digital video camera 30 can be displayed on the screen and operated with keys, or a function knob 28 on the digital video camera 30 can be used to switch among different function choices like taking picture, probing/detection, and data processing and transmission. After the function knob 28 is pressed down, the screen of the digital video camera 30 will display the choices that can be switched. The keys of the digital video camera 30 are used to select the alcohol concentration measuring function combined with the taking picture function. After the measurement, the transmission choice is immediately performed. Which kind of the sensors 12 to be used is then selected. In this embodiment, the external sensor 36 is used to measure the alcohol content in the expired air from the mouth. Next, the satellite positioning function of the data processor 48 can be selected to record the longitude and latitude of the picture-taking site.

After finishing the above settings, a starting button 38 is pressed down. The digital video camera 30 takes a picture, and the sensor 12 detects a source 10 to be measured to get a signal. The signal is transmitted to the circuit component 16. After the circuit component 16 processed the output signal, a display drive circuit (not shown) is used to display the measured alcohol concentration value on the screen of the digital video camera 30. The longitude and latitude of the picture-taking site are recorded by the satellite positioner. The measured alcohol concentration value and longitude and latitude can be stored in a database 18 of a memory card of the digital video camera 30 and simultaneously transmitted along with the taken picture to an external equipment 22 via a transmitter 40. The transmission can be accomplished with a wired or wireless transmission means such as bluetooth, wireless network, infrared transmission, and transmission line. The external equipment 22 can be a personal computer, a printer, or a server like a hospital server, a police business server, and so on, and can be used for digital disease cases or graphic monitor output. For example, the external equipment 22 can make use of infrared transmission to send data to a personal computer for filing, or make use of bluetooth to send data to the police business server for graphic monitor. Because the taken picture and the measured alcohol concentration value and location are immediately transmitted to the external equipment 22 via the transmitter to keep in the archives via, they can't be changed and become credible data. Besides, the digital video camera 30 can further comprise a network card 20. When the digital video camera 30 is connected to a network line, it will get an IP address through the network card 20 to directly connect the Internet for data transmission or download. The power of the sensor 12 on the digital video camera 30 is from the battery of the digital video camera 30. Because the digital video camera 30 is an apparatus in common use, it will have no drawback of apparatus damage due to rusty battery. Moreover, the digital video camera 30 can further have a wired telephone socket 42 for connection with a public telephone line. The digital video camera 30 can be charged by using the public telephone line, or the power of the digital video camera 30 can be directly from the public telephone line. The digital video camera 30 can make use of the network card 20 to be online for browsing webpages. The digital video camera 30 thus has high practicability and convenience.

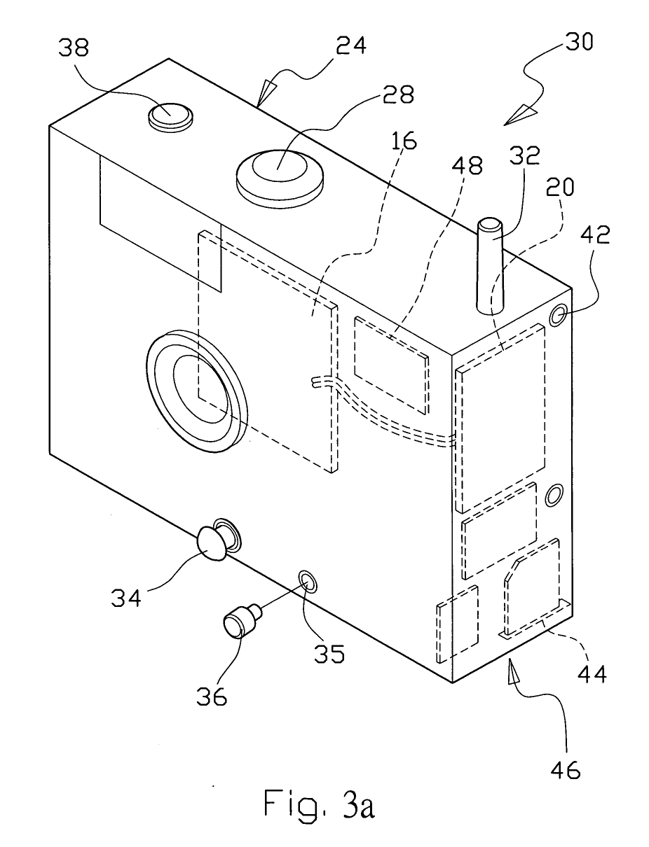

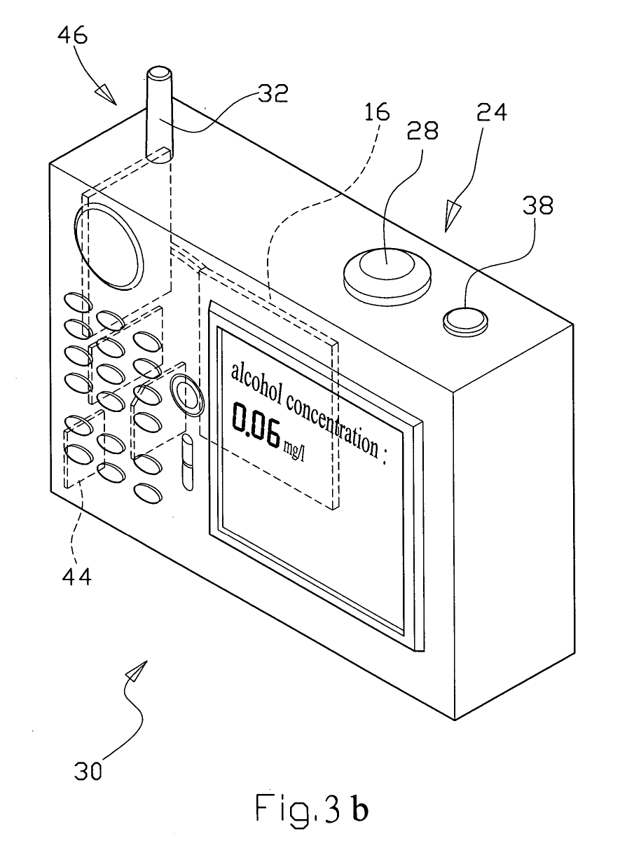

As shown in FIGS. 3a and 3b, a communications transmission device 46 can further be installed on the digital video camera 30 to have the communication function like a mobile phone and replace the transmission function of the transmitter 40. When the function knob 28 is turned to select the communication function choice. The communications transmission device 46 can be used to dial the telephone. When the transmission function is selected, data on the digital video camera 30 can be sent out via the communications transmission device 46. The transmission can be accomplished by a wired or wireless means such as wireless network, infrared transmission, general package radio service (GPRS), code division multiple access (CDMA), or transmission line. In addition to connecting the public telephone line for charging, the wired telephone socket 42 can also connect the public telephone line for dialing the telephone. For example, when the digital video camera 30 is about to run out of battery power, the public telephone line can be used to charge the digital video camera 30, or the power of the digital video camera 30 can directly come from the public telephone line. Moreover, the number of the SIM card in the communications transmission device 46 can be used for dial the telephone. Therefore, the communications transmission device 46 in the digital video camera 30 can be used for communication with the exterior with the public telephone line even at places where the mobile phone can't receive any signal. Furthermore, the communications transmission device 46 can also be separated from the digital video camera 30 to wireless communicate and transmit individually like a mobile phone. It can also use the wired telephone line to communicate with the exterior, supply power, and charge the battery. When the communications transmission device 46 and the digital video camera 30 are separated, datum of the digital video camera 30 can be transmitted by a transceiver (not shown) installed in the communications transmission device 46.

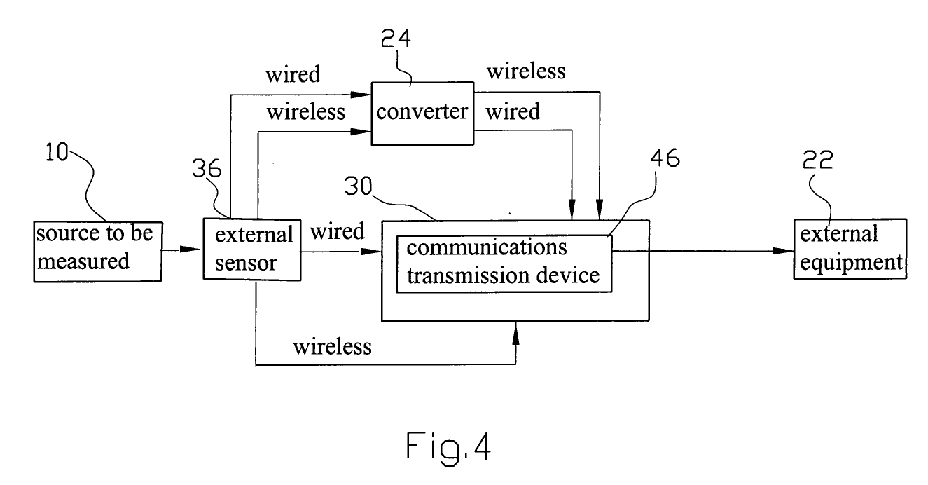

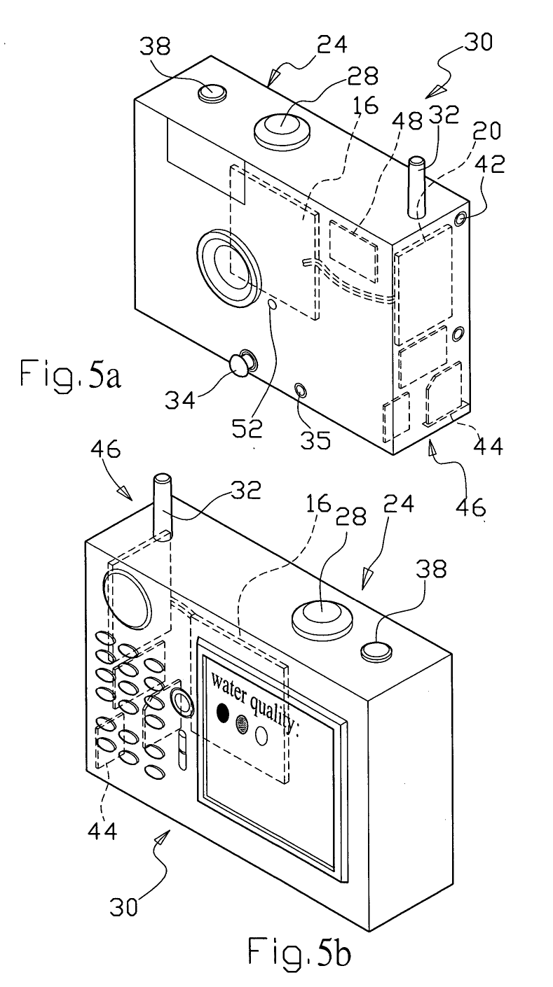

In addition to installation of both the built-in sensor 34 and the external sensor 36, the digital video camera 30 can also have only the built-in sensor 34. Besides, in addition to being directly inserted into the sensor slot 35 of the digital video camera 30 as shown in FIG. 1a, the external sensor 36 can also get connection with the digital video camera 30 in a wireless way. As shown in FIG. 4, a converter 26 can be use to convert from wired way to wireless way or vice versa for transmission to the digital video camera 30. As shown in FIGS. 5a and 5b, a built-in sensor 34 is individually installed below the digital video camera 30. When the function knob 28 is turned to choose the detection function and select the water quality measurement choice, the built-in sensor 34 will be placed into water to be measured. Next, the starting button 38 is pressed down to measure the water quality. The measured result will be displayed on the screen of the digital video camera 30. When only a solid circle is displayed, it means the water is not suitable for drink. Two solid circles mean there are some impurities in the water. Three solid circles mean the water has a good quality and can be drunk safely.

The sensor 12 can be installed on the personal portable digital image capturing device like the digital video camera 30, or can get connection with the personal portable digital image capturing device in a wireless or wired way. The sensor 12 can also be hidden in or externally connected on the personal portable digital image capturing device. If the personal portable digital image capturing device has an infrared receiver, the external sensor 36 can share it for use. The detection result can be stored in the database 18 (e.g., a memory card of digital still camera) of the personal portable digital image capturing device. When previous detection data are required, they can be read out directly via the personal portable digital image capturing device. The detection result can also be stored in an external memory like a multimedia card (MMC), or can be transmitted to a personal computer via the network card 20 and stored therein.

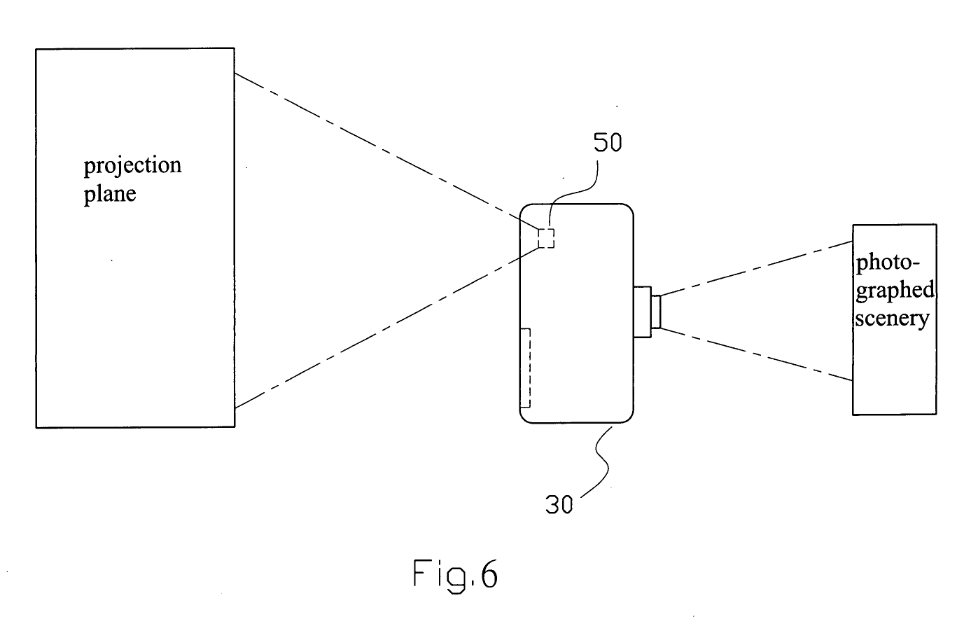

Furthermore, a micro-projector can be built in the digital image capturing device of the present invention. As shown in FIG. 6, the digital video camera 30 has a micro-projector 50 capable of rotating 360° for projection to enlarge and project data in the digital video camera 30 onto any projection plane such as paper, wall, projection screen, or large panel board. Therefore, the digital video camera 30 can use the micro-projector 50 for small meeting briefing to project out an image file in the digital video camera 30 or data processed by the data processor. A map can also be magnified by means of projection to more clearly know the exact place. When a user wants to take his own picture, he can use the micro-projector 50 to project the image onto a paper for adjusting to the optimum angle and then pressing down the shutter button.

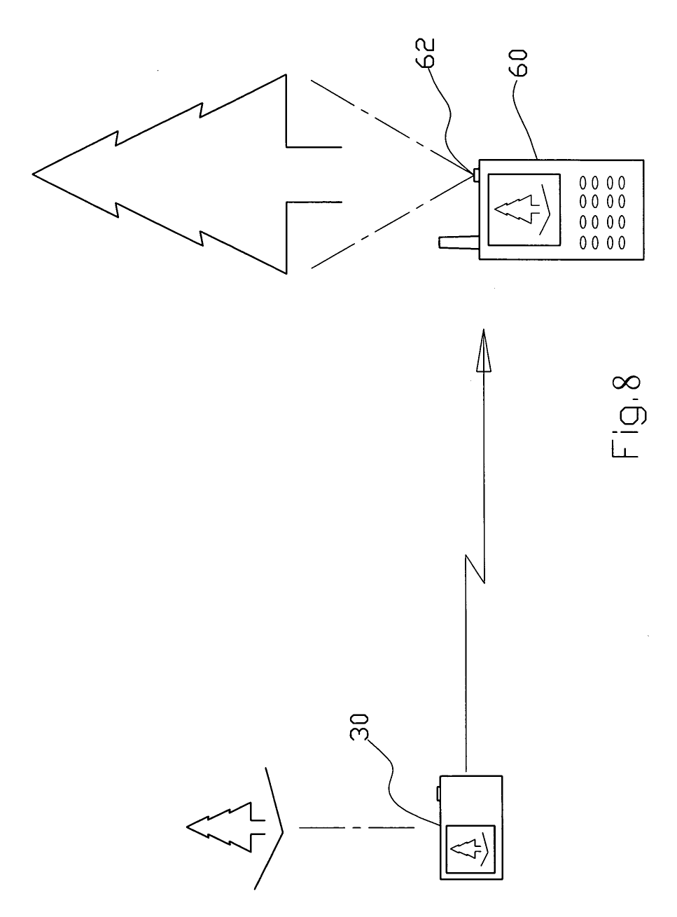

The present invention can also remotely find a view for taking picture. As shown in FIG. 8, a signal transceiver (not shown) is installed on the digital video camera 30. The user has a handheld remote controller 60 capable of receiving signals from the signal transceiver. The user can see the view taken by the lens of the digital video camera 30 on the screen of the remote controller 60 within the range where signals can be sent and received. A micro-projector 62 can also be installed on the remote controller 60 to project the view onto a larger screen for convenient viewing. The remote controller 60 can also send out signals to the signal transceiver to adjust the size of the view found by the digital video camera 30. The digital video camera 30 can also have the range-finding function. As shown in FIG. 5a, a range finder 52 is installed on the digital video camera 30. Through the help of the data processor 48 and GPRS of the communications transmission device 46, the distance from the target taken by the lens to the digital video camera 30 can be calculated out. Because the satellite positioning function of the data processor 48 can locate out the longitude and latitude of the digital video camera 30, the exact position of the target can be known with the distance from the target to the digital video camera 30 calculated out through the range-finding function.

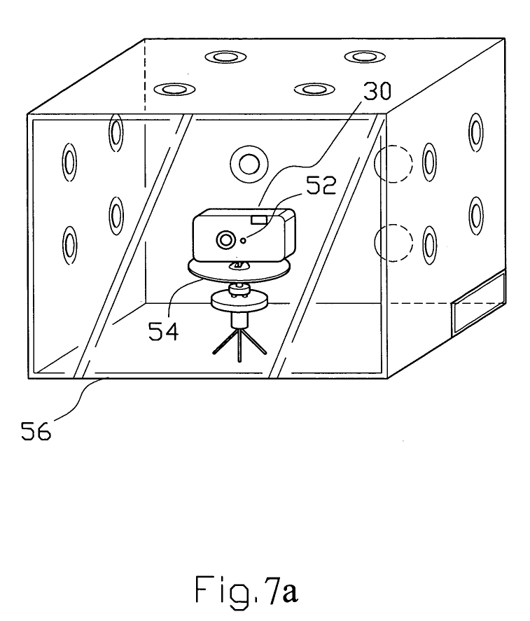

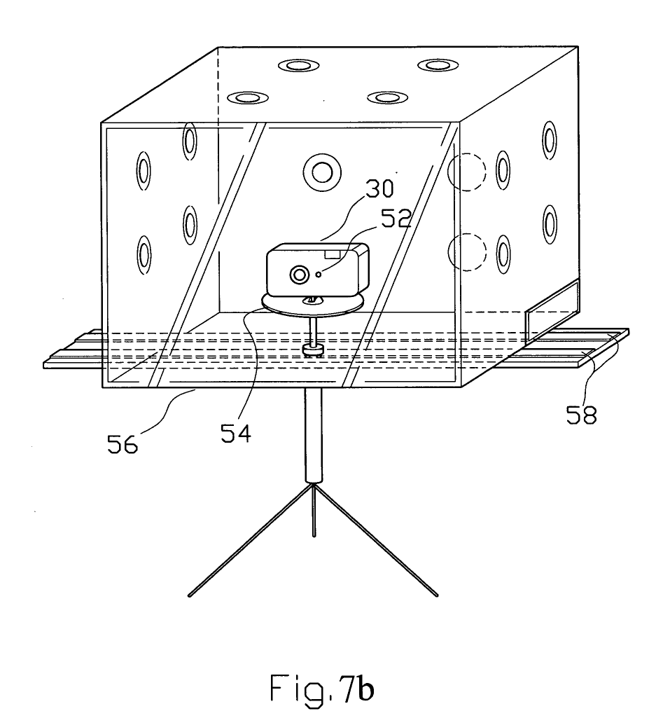

When one wants to use the remote control mode to take a video or picture, in order to avoid damage of the digital video camera 30 due to rain, earthquake, or any unexpected situation, the digital video camera 30 can be placed in a transparent protection box 56, as shown in FIG. 7a. The protection box 56 is a transparent box having anti-corrosive, shockproof, blastproof, and waterproof functions. A remote-control turntable 54 is disposed in the protection box 56. The digital video camera 30 is fixed on the remote-control turntable 54 with their circuits electrically connected together so that the remote-control turntable 54 can be controlled via the signal transceiver. The digital video camera 30 therefore can make 360-degree rotation, ascent and descent, and pitch angle control. As shown in FIG. 7b, the protection box 56 can also be arranged on a slide track 58. The user can remotely control the protection box 56 to move horizontally for taking a picture from a different angle and direction. Moreover, there are scales on the remote-control turntable 54 to display the rotation angle for easier positioning of target. The digital video camera 30 installed in the protection box 56 will thereby act as a fixed monitor station.

To sum up, the present invention integrates the functions of a digital image capturing device like a digital video camera, a communications transmission device like a mobile phone, and a sensor like an alcohol tester. A sensor is installed on a personal portable digital image capturing device for convenient measurement of physical quantities like alcohol concentration, water quality, gas, antiseptic, and insecticides of a target to be measured. The installation of a communications transmission device and a network card and the use of a public telephone line further facilitate communication and data transmission of user and supply power for the personal portable digital image capturing device. The present invention has also the functions of remote control, satellite positioning, and measuring the distance from the target to the personal portable digital image capturing device. Therefore, the functionality and practicability of the personal portable digital image capturing device can be expanded, and the use convenience of measuring tools like alcohol tester and water quality meter can also be enhanced.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. A multifunctional personal portable digital image capturing device, comprising:
a personal portable digital image capturing device;
at least a sensor built in or externally connected with said personal portable digital image capturing device for detecting physical quantities of a source to be measured and outputting the detection result in the form of signal; and
a circuit component built in said personal portable digital image capturing device for processing an output signal of said sensor.

2. The multifunctional personal portable digital image capturing device as claimed in claim 1, wherein said personal portable digital image capturing device can be a digital still camera or a digital camcorder.

3. The multifunctional personal portable digital image capturing device as claimed in claim 1, wherein said sensor is a built-in sensor or an external sensor.

4. The multifunctional personal portable digital image capturing device as claimed in claim 1, wherein said personal portable digital image capturing device has a card slot, and a card can be inserted into said card slot to expand detectable items of said circuit component.

5. The multifunctional personal portable digital image capturing device as claimed in claim 1, wherein said sensor can communicate with said personal portable digital image capturing device in a wired or wireless way.

6. The multifunctional personal portable digital image capturing device as claimed in claim 1, wherein said sensor can detect external environmental factors like gas, alcohol concentration, water quality, mineral, antiseptic, and insecticides.

7. The multifunctional personal portable digital image capturing device as claimed in claim 1, wherein said personal portable digital image capturing device further comprises a display drive circuit for directly displaying said detection result on a screen of said personal portable digital image capturing device.

8. The multifunctional personal portable digital image capturing device as claimed in claim 1, wherein said detection result can be stored in a database of said personal portable digital image capturing device or an external memory.

9. The multifunctional personal portable digital image capturing device as claimed in claim 1, wherein said detection result can be sent to an external equipment by using a transmitter.

10. The multifunctional personal portable digital image capturing device as claimed in claim 9, wherein said transmitter can be a transmitter of said personal portable digital image capturing device or a wired or wireless transmission means such as bluetooth, infrared, or transmission line.

11. The multifunctional personal portable digital image capturing device as claimed in claim 9, wherein said external equipment can be a personal computer, a printer, or a server.

12. The multifunctional personal portable digital image capturing device as claimed in claim 1, wherein said personal portable digital image capturing device further comprises a network card to give an IP address to said personal portable digital image capturing device.

13. The multifunctional personal portable digital image capturing device as claimed in claim 1, wherein said personal portable digital image capturing device has also a socket capable of connecting externally with a public telephone line.

14. The multifunctional personal portable digital image capturing device as claimed in claim 13, wherein said personal portable digital image capturing device can also use said public telephone line as the source of power supply in addition to its own battery.

15. The multifunctional personal portable digital image capturing device as claimed in claim 13, wherein said personal portable digital image capturing device can be charged through said socket by using said public telephone line.

16. The multifunctional personal portable digital image capturing device as claimed in claim 1, wherein said personal portable digital image capturing device has at least a function knob capable of switching the functions of image capturing, probing/detection, data processing, and data transmission.

17. The multifunctional personal portable digital image capturing device as claimed in claim 1, wherein a user can directly read a menu on a screen of said personal portable digital image capturing device.

18. The multifunctional personal portable digital image capturing device as claimed in claim 1, wherein said personal portable digital image capturing device has also a data processor capable of performing the functions of analysis, calculation, and plotting to said detection result.

19. The multifunctional personal portable digital image capturing device as claimed in claim 1, wherein said personal portable digital image capturing device can make use of voice control or a touch panel to select the shoot mode.

20. The multifunctional personal portable digital image capturing device as claimed in claim 1, wherein said personal portable digital image capturing device can choose the size of photo.

21. The multifunctional personal portable digital image capturing device as claimed in claim 1, wherein said personal portable digital image capturing device has also a satellite positioner used to record the longitude and latitude of the picture-taking site.

22. The multifunctional personal portable digital image capturing device as claimed in claim 1, wherein several languages are provided for said personal portable digital image capturing device for use.

23. The multifunctional personal portable digital image capturing device as claimed in claim 1, wherein said personal portable digital image capturing device can be operated with a remote controller.

24. The multifunctional personal portable digital image capturing device as claimed in claim 23, wherein said remote controller has a screen capable of viewing the scene selected by said personal portable digital image capturing device.

25. The multifunctional personal portable digital image capturing device as claimed in claim 23, wherein said remote controller has a micro-projector, and a user can remotely project out the scene selected by said personal portable digital image capturing device via said micro-projector.

26. The multifunctional personal portable digital image capturing device as claimed in claim 1, wherein said personal portable digital image capturing device has the function of range-finding.

27. The multifunctional personal portable digital image capturing device as claimed in claim 1, wherein said personal portable digital image capturing device can be installed in a transparent protection box.

28. The multifunctional personal portable digital image capturing device as claimed in claim 27, wherein said protection box has anti-corrosive, shockproof, blastproof, and waterproof functions.

29. The multifunctional personal portable digital image capturing device as claimed in claim 27, wherein a turntable is disposed in said protection box, and said personal portable digital image capturing device is placed on said turntable to be able to make 360-degree rotation, ascent and descent, and pitch angle control.

30. The multifunctional personal portable digital image capturing device as claimed in claim 27, wherein said protection box can move horizontally on a track.

31. The multifunctional personal portable digital image capturing device as claimed in claim 1, wherein said personal portable digital image capturing device has a built-in micro-projector so that images in said personal portable digital image capturing device can be projected out via said micro-projector.

32. A multifunctional personal portable digital image capturing device comprising:
a personal portable digital image capturing device;
at least a sensor built in or externally connected with said personal portable digital image capturing device for detecting physical quantities of a source to be measured and outputting the detection result in the form of signal;
a communications transmission device installed on said personal portable digital image capturing device and capable of communicating with the exterior in a wireless way; and
a circuit component built in said personal portable digital image capturing device for processing signals of said sensor and said communications transmission device.

33. The multifunctional personal portable digital image capturing device as claimed in claim 32, wherein said personal portable digital image capturing device can be a digital still camera or a digital camcorder.

34. The multifunctional personal portable digital image capturing device as claimed in claim 32, wherein said sensor is a built-in sensor or an external sensor.

35. The multifunctional personal portable digital image capturing device as claimed in claim 32, wherein said personal portable digital image capturing device has a card slot, and a card can be inserted into said card slot to expand detectable items of said circuit component.

36. The multifunctional personal portable digital image capturing device as claimed in claim 32, wherein said sensor can communicate with said personal portable digital image capturing device in a wired or wireless way.

37. The multifunctional personal portable digital image capturing device as claimed in claim 32, wherein said sensor can detect external environmental factors like gas, alcohol concentration, water quality, mineral, antiseptic, and insecticides.

38. The multifunctional personal portable digital image capturing device as claimed in claim 32, wherein said personal portable digital image capturing device further comprises a display drive circuit for directly displaying said detection result on a screen of said personal portable digital image capturing device.

39. The multifunctional personal portable digital image capturing device as claimed in claim 32, wherein said detection result can be stored in a database of said personal portable digital image capturing device or an external memory.

40. The multifunctional personal portable digital image capturing device as claimed in claim 32, wherein said detection result can be sent to an external equipment by using a transmitter.

41. The multifunctional personal portable digital image capturing device as claimed in claim 40, wherein said transmitter can be a transmitter of said personal portable digital image capturing device or a wired or wireless transmission means such as bluetooth, infrared, or transmission line.

42. The multifunctional personal portable digital image capturing device as claimed in claim 40, wherein said external equipment can be a personal computer, a printer, or a server.

43. The multifunctional personal portable digital image capturing device as claimed in claim 32, wherein said personal portable digital image capturing device further comprises a network card to give an IP address to said personal portable digital image capturing device.

44. The multifunctional personal portable digital image capturing device as claimed in claim 32, wherein said personal portable digital image capturing device has also a socket capable of connecting externally with a public telephone line.

45. The multifunctional personal portable digital image capturing device as claimed in claim 44, wherein said personal portable digital image capturing device can also use said public telephone line as the source of power supply in addition to its own battery.

46. The multifunctional personal portable digital image capturing device as claimed in claim 44, wherein said personal portable digital image capturing device can be charged through said socket by using said public telephone line.

47. The multifunctional personal portable digital image capturing device as claimed in claim 32, wherein said personal portable digital image capturing device has at least a function knob capable of switching the functions of image capturing, probing/detection, data processing, and data transmission.

48. The multifunctional personal portable digital image capturing device as claimed in claim 44, wherein said communications transmission device can use said public telephone line to make wired communications transmission.

49. The multifunctional personal portable digital image capturing device as claimed in claim 32, wherein a user can directly read a menu on a screen of said personal portable digital image capturing device.

50. The multifunctional personal portable digital image capturing device as claimed in claim 32, wherein said personal portable digital image capturing device has also a data processor capable of performing the functions of analysis, calculation, and plotting to said detection result.

51. The multifunctional personal portable digital image capturing device as claimed in claim 32, wherein said personal portable digital image capturing device can make use of voice control or a touch panel to select the shoot mode.

52. The multifunctional personal portable digital image capturing device as claimed in claim 32, wherein said personal portable digital image capturing device can choose the size of photo.

53. The multifunctional personal portable digital image capturing device as claimed in claim 32, wherein said personal portable digital image capturing device has also a satellite positioner used to record the longitude and latitude of the picture-taking site.

54. The multifunctional personal portable digital image capturing device as claimed in claim 32, wherein several languages are provided for said personal portable digital image capturing device for use.

55. The multifunctional personal portable digital image capturing device as claimed in claim 32, wherein said personal portable digital image capturing device can be operated with a remote controller.

56. The multifunctional personal portable digital image capturing device as claimed in claim 55, wherein said remote controller has a screen capable of viewing the scene selected by said personal portable digital image capturing device.

57. The multifunctional personal portable digital image capturing device as claimed in claim 55, wherein said remote controller has a micro-projector, and a user can remotely project out the scene selected by said personal portable digital image capturing device via said micro-projector.

58. The multifunctional personal portable digital image capturing device as claimed in claim 32, wherein said personal portable digital image capturing device has the function of range-finding.

59. The multifunctional personal portable digital image capturing device as claimed in claim 32, wherein said personal portable digital image capturing device can be installed in a transparent protection box.

60. The multifunctional personal portable digital image capturing device as claimed in claim 59, wherein said protection box has anti-corrosive, shockproof, blastproof, and waterproof functions.

61. The multifunctional personal portable digital image capturing device as claimed in claim 59, wherein a turntable is disposed in said protection box, and said personal portable digital image capturing device is placed on said turntable to be able to make 360-degree rotation, ascent and descent, and pitch angle control.

62. The multifunctional personal portable digital image capturing device as claimed in claim 59, wherein said protection box can move horizontally on a track.

63. The multifunctional personal portable digital image capturing device as claimed in claim 32, wherein said personal portable digital image capturing device has a built-in micro-projector so that images in said personal portable digital image capturing device can be projected out via said micro-projector.

64. The multifunctional personal portable digital image capturing device as claimed in claim 32, wherein said communications transmission device can be separated from said digital video camera to communicate and transmit individually by wireless means or said wired telephone line.

65. The multifunctional personal portable digital image capturing device as claimed in claim 64, wherein said communications transmission device can use said wired telephone line to communicate with the exterior, supply power, and charge the battery.

66. The multifunctional personal portable digital image capturing device as claimed in claim 64, wherein said communications transmission device has a transceiver on it, and when said communications transmission device is separated from said digital video camera, datum of said digital video camera can be transmitted by said transceiver.
